(19) United States
(12) Patent Application Publication
(10) Pub. No.: US 2013/0089838 A1
(43) Pub. Date: Apr. 11, 2013

(54) Food safety and risk analyzer

(71) Applicants: Lisa Jeanne Adkins, Albuquerque, NM (US); John James Cousins, III, Albuquerque, NM (US)

(72) Inventors: Lisa Jeanne Adkins, Albuquerque, NM (US); John James Cousins, III, Albuquerque, NM (US)

(21) Appl. No.: 13/317,010

(22) Filed: Oct. 6, 2011

(51) Int. Cl. G09B 19/00

(52) U.S. Cl. 434/127

(57) ABSTRACT

Disclosed is a system and methods for gathering, analyzing, querying, and providing food safety and risk profile information to end-users via a central or distributed database across a variety of communications modes. It is a computer based system providing the ability for the user to remotely query the database of food safety information and deliver a risk profile and analysis of the food items to the user via a mobile handset such as a Smartphone, Digital Personal Assistant (PDA), tablet, or computer. The database content on food safety is developed through intelligence gathering around the world, historical analysis of food borne pathogen and illness cases and their origins and provenance, and criteria and analytic processes to characterize and rate food risk. The invention also includes analytic techniques to derive predictive indicators of potential food safety threats and risks, and techniques for gathering and analyzing historical query information for system learning.

### BACKGROUND OF THE INVENTION

1. Field of the Invention

The present invention is a system and method to provide users with information related to food safety and risk of food related illness caused by food borne pathogens, contamination and spoilage. The user is able to search and query a database of information on various food items for their relative risk of being tainted by food borne pathogens and other illness producing artifacts.

2. Description of the Prior Art

U.S. Pat. No. 6,865,261 describes a method for making a personal gastronomic decision or receiving instruction involving price, availability, safety and convenience information for food, such as for dining. The method involves sending an inquiry from a display device to a central server and transmitting the inquiry from the server to an information source. On receiving an action from the source to the server, the method involves personalizing the action for a particular user, interfacing the action with the display device from the server, and displaying the action. The display device may be a mobile device such as a Palm Pilot or a cell phone. The display device may have a tactile, audible, or visual interface. Any language may be translated, and any of the steps may be performed at a desired time.

This method is limited by not teaching how information is gathered on food safety and analyzed for risk stratification and profiling. It does not teach or describe a method of reporting food borne pathogen risk in commodity foods purchased in markets such as fruits, vegetables, seafood, and meats. This patent is vendor-centric and is directed towards providing information meal suppliers on how to prepare foods to meet specific customer needs and requirements. It details the communication of gastronomic and food preparation preferences.

U.S. Pat. No. 6,874,000 describes a food safety system and method that provides a comprehensive consumer risk distribution model, which can be applied to any food item. Additionally, the present invention automatically evaluates consumer risk based on how much contaminated food is at each stage of the food distribution process according to the consumer risk distribution model, allowing for quick and accurate determinations as to the efficacy of a trace recall effort. A further element of the present invention provides expert analysis of data to detect and identify food events from sporadic information. Finally, the real time detection system provides early warning data in order to intercept isolated food contamination events before the contaminated food products reach the consuming public.

This patent describes a method for responding to a food contamination incident. It does not teach or describe a method or system of querying and reporting predictive food safety risk profile information to end users.

U.S. patent application 20050131723 describes a food safety system and method that provides a comprehensive consumer risk distribution model, which can be applied to any food item. Additionally, the present invention automatically evaluates consumer risk based on how much contaminated food is at each stage of the food distribution process according to the consumer risk distribution model, allowing for quick and accurate determinations as to the efficacy of a trace recall effort. A further element of the present invention provides expert analysis of data to detect and identify food events from sporadic information. Finally, the real time detection system provides early warning data in order to intercept isolated food contamination events before the contaminated food products reach the consuming public.

This patent application describes a tracking system for the food distribution chain based on identifying contaminated food in the distribution system in order to affect recalls. This is based on physical tracking criteria and monitoring system. This patent application deals primarily with tools to assist regulatory agencies in their efforts to identify probable sources of contamination incidents and to make recalls. It does not teach or describe a method or system of querying and reporting predictive food safety risk profile information to end users via their smartphones and computers.

### SUMMARY OF THE INVENTION

The present invention is a system and methods for gathering, analyzing, querying, and providing food safety information to end-users. It is a computer based system providing the ability for the user to remotely query the database of food safety information and deliver a risk profile and analysis of the food items to the user via a mobile handset such as a Smartphone, Personal Digital Assistant (PDA), tablet, or computer. The database content on food safety is developed through intelligence gathering around the world and historical analysis of food borne pathogen and illness cases and their origins and provenance.

It is therefore a primary object of the present invention to provide actionable decision making information on food safety to the end user.

It is another object of the present invention to create a prevention focused tool to enhance public health by reducing the cases of food borne illness and death.

It is another object of the present invention to create a predictive model to assess, calculate and notify end users of potential food safety risks to reduce cases of food borne illness and death.

It is another object of the present invention to gather and present information on the global food chain in a timely manner.

It is another object of the present invention to present this information in easily graspable ways and to create a pleasant and informative user experience.

It is another object of the present invention to generate risk models, profiles and probablities using such factors as regional and supplier history, food safety-inspection failures, FDA and other regulatory agency actions worldwide, consumer complaints, epidemiological patterns of food borne illness, geo-political developments and weather patterns and natural disasters.

It is another object of the present invention to capture query information via auto-fill keyboard entry, barcode scanning, visual capture, and image recognition and selection.

It is another object of the present invention to provide food safety information in a form and format that is readily adaptable to various types of computer and mobile devices.

It is another object of the present invention to educate shoppers about the safety and reliability of their food purchases such as meats, fish, shellfish, fruits and vegetables.

### BRIEF DESCRIPTION OF THE DRAWINGS

FIG. 1 is a sample of one of the graphical user interfaces that will provide query screens and prompts.

FIG. 2 is a sample of one of the graphical user interfaces that will display query results and risk profile information.

FIG. 3 is a systems diagram outlining the various system components and how they are connected.

### DETAILED DESCRIPTION OF THE INVENTION

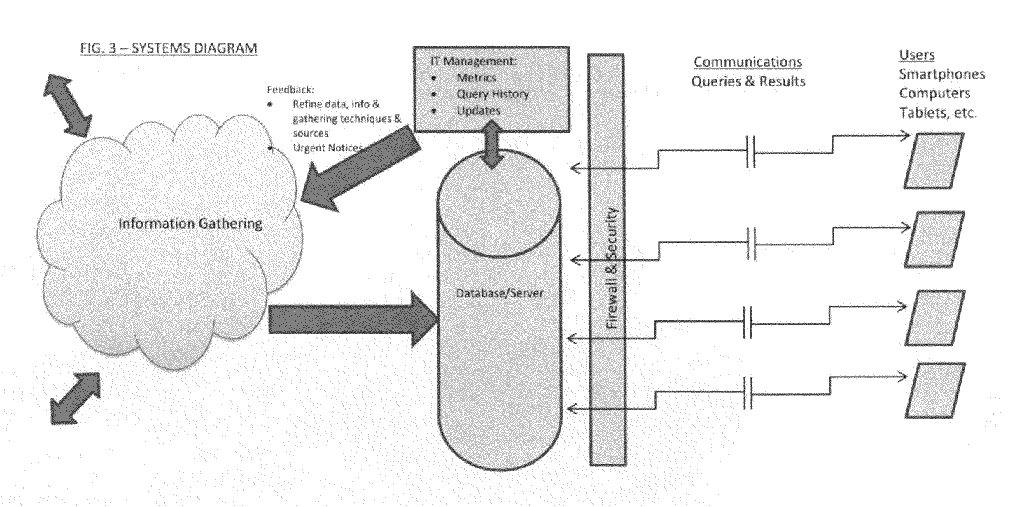

FIG. 3 shows a systems diagram and flow chart of the best mode for carrying out the invention contemplated by the inventors of the food safety and risk analyzer. It is a computer based system providing the ability for the user to remotely query the database of food safety information and deliver a risk profile and analysis of the food items to the user via a mobile handset such as a Smartphone, Digital Personal Assistant (PDA), tablet, or computer. The database content on food safety is developed through intelligence gathering around the world and historical analysis of food borne pathogen and illness cases and their origins and provenance.

### Content

The content is the development and continual monitoring and refining of information related to items in food categories relative to their safety and risk of being contaminated, spoiled, or carrying food borne pathogens. The content will be developed using intelligence gathering techniques worldwide to generate risk models, profiles and probabilities using such factors as regional and supplier history, food safety-inspection failures, FDA and other regulatory agency actions worldwide, consumer complaints, epidemiological patterns of food borne illness, geo-political developments and weather patterns.

This information will be coded, uploaded and stored into a searchable database. It will be continually updated to maintain the pertinence of the information and data.

### Predictive Risk Assessment

The data will be analyzed to calculate and derive risk models and assessments and generate predictive, probabilistic forecasting of potential safety and risk issues.

### Queries

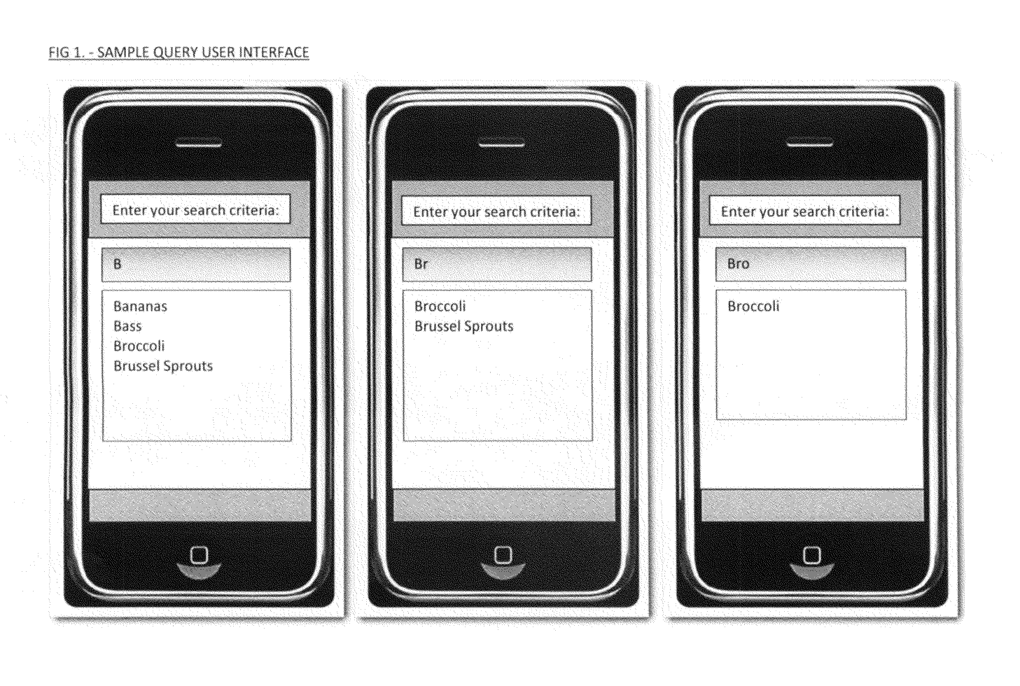

FIG. 1 is a sample of one of the graphical user interfaces that will provide query screens and prompts. The database will respond to interrogation and queries from users. The queries will relate to the safety and reliability of their food purchases such as meats, fish, shellfish, fruits and vegetables. This will be enabled in multiple ways such as auto-fill keyboard entry, barcode scanning, visual capture, and image recognition and selection. Communication between the query device and the database will be enabled via various communications paths such as wireless networks and mobile and hard-wire telephony. The information derived and in response to queries will be delivered back to the user via similar communications networks. The system will also provide methods of feedback to refine the content and search features by analyzing historical queries to gain insight into how the invention is being used and how to better accommodate and enhance the user experience.

### Presentation of Information

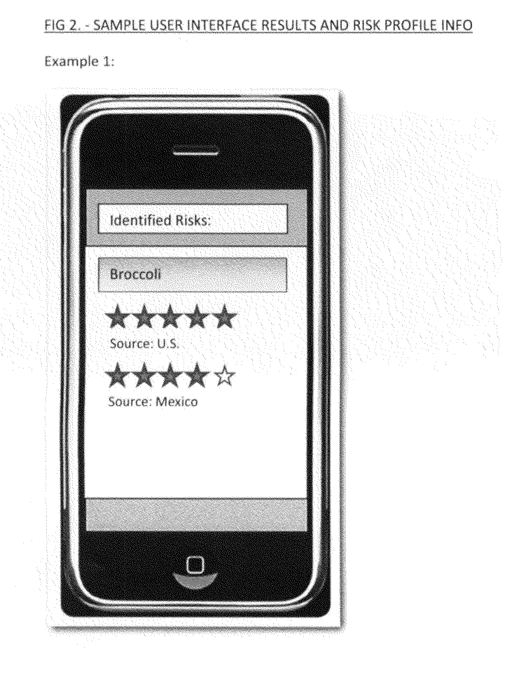

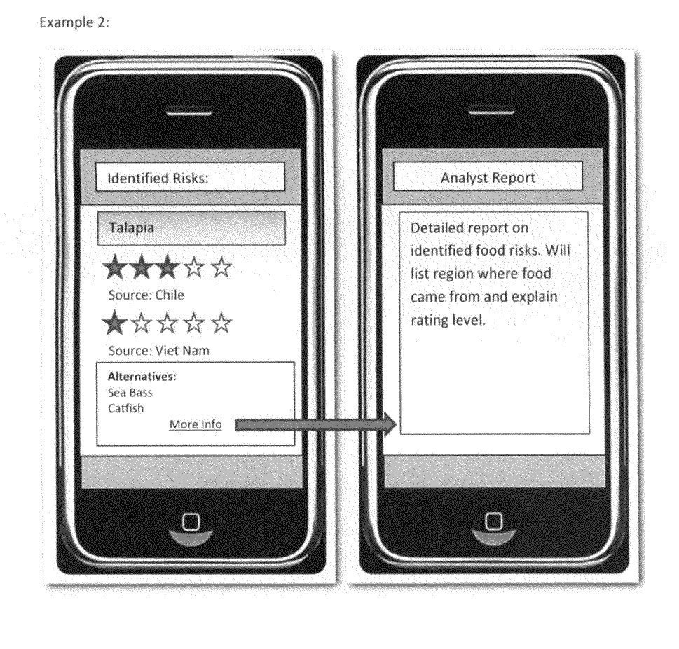

FIG. 2 is a sample of one of the graphical user interfaces that will display query results and risk profile information.

The user experience of the data and information will be organized and presented in multiple ways. Graphical User Interfaces are used in the best mode contemplated by the inventors in order to present the data in the most easily graspable terms for decision making by the user. Displays will start with high-level safety and risk profiling information with the ability to drill down to more detailed and specific assessments and supporting documentation and analysis. The display of results will also include suggestions for alternative food choices that are safer and less risky based on the information collected in the database.

### Delivery Devices

Users will interface with the database via a mobile handset such as a Smartphone, Digital Personal Assistant (PDA), tablet, or computer.

The problems addressed by the food safety and risk analyzer are many as can be easily see by those skilled in this art. According to recent data from the Center for Disease Control and Prevention, each Year in the U.S. approximately 48 million people (1 in 6 Americans) get sick, 128,000 are hospitalized, and 3,000 die from food borne diseases.

Worldwide, food safety has been in the spotlight amid the aftermath of an E. coli outbreak in Europe, which caused the deaths of 48 and sickened 4,000. Food-borne and waterborne diseases cause deaths of 2.2 million people each year, according to the World Health Organization.

It will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A system for determining food safety and risk comprising; intelligence gathering, monitoring and analysis of information; identification of sources; searchable database where information resides and is stored; communication networks and devices to connect users to data and information; user interfaces with easy front-ends and the ability to drill down to more detailed information, that operate across a multitude of mobile and computer platforms.

2. An information content development and maintenance system according to claim 1 wherein information is gathered from various sources worldwide and monitored by professionals who have expertise in: intelligence gathering and analysis; languages and regional expertise; agriculture; food processing; global food chain; food borne pathogens; epidemiology and illness; and computer systems.

3. Database and storage media according to claim 1 that are scalable; redundant; secure; fail-safe; where the food safety and risk data reside.

4. Computer systems according to claim 1 that operate the algorithms and criteria and analytic processes to characterize and rate food risk and probabilities and generate predictive, operable result information for decision making.

5. Computer systems according to claim 1 that house history of queries to the system and analytics of the queries that operate as a feedback system in order to refine, expand and streamline the systems operation, availability and robustness.

6. Communications networks and systems according to claim 1 consisting of devices to connect users with the database and computer systems that operate on the queries and generate and transmit the results.

7. Graphical and other user interface systems according to claim 1 that allow a user to quickly, and without ambiguity, generate a query for a specific food item such as perishables such as: meats, seafood, fruits and vegetables.

8. Graphical and other user interface systems according to claim 1 that allow a user to receive and comprehend results of queries presented in a fashion that is easily graspable for decision making on the front-end and allows for the ability to access more detailed information.

9. Multiple user interface systems according to claim 1 that operate and allow access across various user platforms and operating systems such as: smartphones, tablets, and computers.

10. System and methods comprising an embodiment of the invention as an application for smartphones, personal digital assistants, tablet computers, and computers.

11. System and methods according to claim 10 including graphical user interfaces to generate queries to interrogate the databases of food risk and safety information.

12. System and methods according to claim 10 consisting of modes and channels of communications between the user device and the central databases and computer system.

13. System and methods according to claim 10 comprising graphical user interfaces to codify and present results of searches and queries to users along with suggestions of safer and less risky alternatives.

14. A method for determining food safety and risk comprising the steps of: identifying sources; gathering information; Continually scanning and capturing pertinent data to populate database; criteria and analytic processes to characterize and rate food risk; synchronization techniques to update database in a timely manner in order to keep information current and useful; analytic techniques to derive predictive indicators of potential food safety threats and risks; methods to interrogate and query database remotely from user devices; user interfaces for queries to database and display of results that operate across a variety of user platforms; techniques of creating an efficient user experience and ability to asses and grasp the meaning of the results for quick decision making; results of queries will include suggestions of safer and less risky food alternatives; techniques for gathering and analyzing historical query information for system learning. An information content development and maintenance system according to claim 1 wherein information is gathered from various sources worldwide and monitored by professionals who have expertise in: intelligence gathering and analysis; languages and regional expertise; agriculture; food processing; global food chain; food borne pathogens; epidemiology and illness; and computer systems.

15. Information content development and maintenance methods according to claim 14 wherein information is gathered from various sources worldwide and monitored according to rules developed and administered by professionals who have expertise in: intelligence gathering and analysis; languages and regional expertise; agriculture; food processing; global food chain; food borne pathogens; epidemiology and illness; and computer systems.

16. A method of database entry according to claim 14 between the intelligence gathering and database including tables and structure of database entry and such synchronization techniques as optimized delta T synchronization and urgent updates.

17. A method of analytic techniques according to claim 14 to derive predictive indicators of food safety and risk comprising: statistical analysis of historical data related to: recall notices and alerts, geographical and company sourcing, and spoilage and contamination.

18. A method of analysis according to claim 14 to generate probabilistic indicators of future food safety and risk events.

19. A method according to claim 14 to provide for the display of better options and less risky food alternatives, in the category queried, as part of the results.

20. A method of gathering and analyzing historical query information according to claim 14 in order to generate feedback tools to refine the intelligence gathering efforts, query and interrogation methods, results and alternative suggestions to create a system that has the ability to learn and refine itself over time.
